(19) United States
(12) Patent Application Publication
(10) Pub. No.: US 2022/0284442 A1
(43) Pub. Date: Sep. 8, 2022

(54) METHOD AND SYSTEM FOR VERIFICATION OF BUSINESS PROCESS ADHERENCE TO STANDARDS

(71) Applicant: JPMorgan Chase Bank, N.A., New York, NY (US)

(72) Inventors: Natraj RAMAN, London (GB); Sameena SHAH, Scarsdale, NY (US); Maria Manuela VELOSO, New York, NY (US)

(73) Assignee: JPMorgan Chase Bank, N.A., New York, NY (US)

(21) Appl. No.: 17/190,695

(22) Filed: Mar. 3, 2021

(51) Int. Cl. G06Q 30/00; G06Q 10/06; G06K 9/00

(52) U.S. Cl. CPC G06Q 30/018; G06Q 10/067; G06K 9/00449

(57) ABSTRACT

A method and a system for verifying that a process conforms to a standard, such as a governmental regulation or a quality standard, are provided. The method includes: obtaining first information that relates to an entity that has executed a process, the first information including an entity identification, a standard, and at least one document that relates to a result of an execution of the first process; extracting a specific type of information from the document(s); and determining, based on the extracted information, whether the execution of the process by the entity satisfies the standard. The method may also include determining a confidence level value that relates to a degree of uncertainty of the determination of whether the standard has been satisfied, and the confidence level value may be used for adjusting the standard and/or for adjusting the verification method.

### BACKGROUND

### 1. Field of the Disclosure

This technology generally relates to methods and systems for ensuring conformance to standards, and more particularly, to methods and systems for using artificial intelligence techniques to verify that business processes adhere to established standards and norms.

### 2. Background Information

Financial institutions define and follow standards, to comply with regulatory requirements, maintain product quality, eliminate risks, and ensure smooth functioning of their businesses. Generally, there is a requirement that the extent of adherence to such standards must be verified periodically. Such a verification is typically performed during an audit cycle, in which human analysts manually examine a sampled set of evidences and validate conformance to specified standards. The auditing process is generally independent of the evidence collection process.

The manual verification process has several limitations. First, systematic errors in human judgment due to confirmation bias or overconfidence effect may occur. Second, interpretation of evidences may vary from person to person, resulting in unpredictability. Third, retaining human attention for repetitive tasks is onerous. Finally, it is difficult to determine explanations for human actions at scale.

Accordingly, there is a need for methods and systems for using artificial intelligence techniques to verify that business processes adhere to established standards and norms.

### SUMMARY

The present disclosure, through one or more of its various aspects, embodiments, and/or specific features or sub-components, provides, inter alia, various systems, servers, devices, methods, media, programs, and platforms for using artificial intelligence techniques to verify that business processes adhere to established standards and norms.

According to an aspect of the present disclosure, a method for using artificial intelligence techniques to verify that business processes adhere to established standards and norms is provided. The method is implemented by at least one processor. The method includes: obtaining, by the at least one processor, first information that relates to a first entity that has executed a first process, the first information including an identification of the first entity, a standard that relates to the first process, and at least one document that relates to a result of an execution of the first process; extracting, by the at least one processor, second information from the at least one document, the second information including a predetermined type of information; and determining, by the at least one processor based on the extracted second information, whether the execution of the first process by the first entity satisfies the standard.

The determining may include comparing a content of the predetermined type of information with predetermined target content and determining whether the execution of the first process by the first entity satisfies the standard based on a result of the comparing.

The extracting may include using information that indicates a predetermined portion of the at least one document within which the predetermined type of information is expected to exist to retrieve the second information.

The method may further include: monitoring a set of mouse clicks and keyboard strokes performed by a first user while the first user is determining whether an execution of the first process by a second entity satisfies the standard; determining a document type of the at least one document based on a result of the monitoring; and determining the predetermined type of information included in the second information and at least one from among the predetermined target content and the information that indicates a predetermined portion of the at least one document within which the predetermined type of information is expected to exist based on the result of the monitoring.

The information that indicates a predetermined portion of the at least one document within which the predetermined type of information is expected to exist may include at least one page number of the at least one document.

The predetermined type of information may include a title of the at least one document.

The method may further include determining a confidence level value that relates to a degree of uncertainty with respect to the determining of whether the execution of the first process by the first entity satisfies the standard.

The method may further include comparing the determined confidence level value with a predetermined threshold. The determining of whether the execution of the first process by the first entity satisfies the standard may be based on a result of the comparing.

The method may further include using the determined confidence level value to adjust at least one from among the standard and the predetermined type of information to be used for determining whether the standard is satisfied in a future verification.

The standard may include at least one from among a governmental regulation, a predetermined quality standard, and a standard that relates to ensuring that the process is executed smoothly.

According to another exemplary embodiment, a computing apparatus for verifying that a process conforms to a standard includes a processor; a memory; and a communication interface coupled to each of the processor and the memory. The processor is configured to: obtain first information that relates to a first entity that has executed a first process, the first information including an identification of the first entity, a standard that relates to the first process, and at least one document that relates to a result of an execution of the first process; extract second information from the at least one document, the second information including a predetermined type of information; and determine, based on the extracted second information, whether the execution of the first process by the first entity satisfies the standard.

The processor may be further configured to compare a content of the predetermined type of information with a predetermined target content and to determine whether the execution of the first process by the first entity satisfies the standard based on a result of the comparison.

The processor may be further configured to use information that indicates a predetermined portion of the at least one document within which the predetermined type of information is expected to exist to retrieve the second information.

The processor may be further configured to: monitor a set of mouse clicks and keyboard strokes performed by a first user while the first user is determining whether an execution of the first process by a second entity satisfies the standard; determine a document type of the at least one document based on a result of the monitoring; and determine the predetermined type of information included in the second information and at least one from among the predetermined target content and the information that indicates a predetermined portion of the at least one document within which the predetermined type of information is expected to exist based on the result of the monitoring.

The information that indicates a predetermined portion of the at least one document within which the predetermined type of information is expected to exist may include at least one page number of the at least one document.

The predetermined type of information may include a title of the at least one document.

The processor may be further configured to determine a confidence level value that relates to a degree of uncertainty with respect to the determination of whether the execution of the first process by the first entity satisfies the standard.

The processor may be further configured to compare the determined confidence level value with a predetermined threshold, and to determine whether the execution of the first process by the first entity satisfies the standard based on a result of the comparison.

The processor may be further configured to use the determined confidence level value to adjust at least one from among the standard and the predetermined type of information to be used for determining whether the standard is satisfied in a future verification.

The standard may include at least one from among a governmental regulation, a predetermined quality standard, and a standard that relates to ensuring that the process is executed smoothly.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer s

FIG. 2 illustrates an exemplary diagram of a network environment.

FIG. 3 shows an exemplary system for implementing a method for using artificial intelligence techniques to verify that business processes adhere to established standards and norms.

FIG. 4 is a flowchart of an exemplary process for implementing a method for using artificial intelligence techniques to verify that business processes adhere to established standards and norms.

FIG. 5 is a diagram that illustrates key components of a cognitive workflow representation of a method for using artificial intelligence techniques to verify that business processes adhere to established standards and norms, according to an exemplary embodiment.

FIG. 6 is a diagram that illustrates a conversion of a manual workflow to a machine-understandable representation of a method for using artificial intelligence techniques to verify that business processes adhere to established standards and norms, according to an exemplary embodiment.

FIG. 7 is a diagram that illustrates an verification system for validating whether entity information available in emails are present in the body of the email rather than in signature or header blocks, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

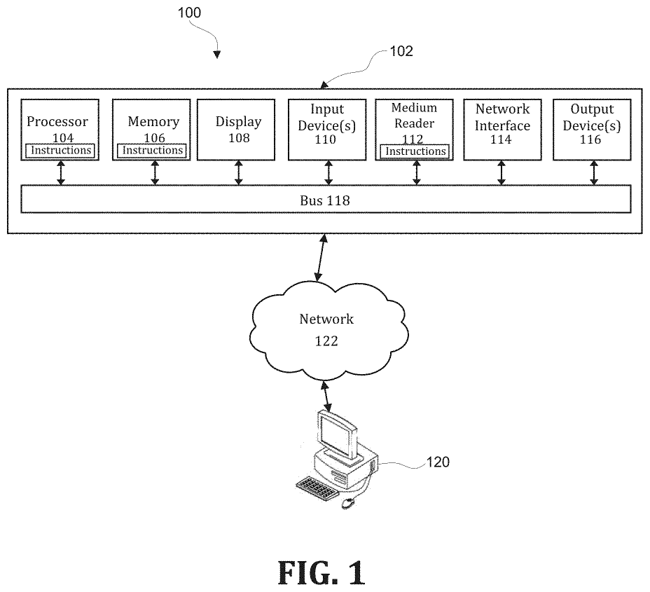

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular cattier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting; diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which a commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using artificial intelligence techniques to verify that business processes adhere to established standards and norms.

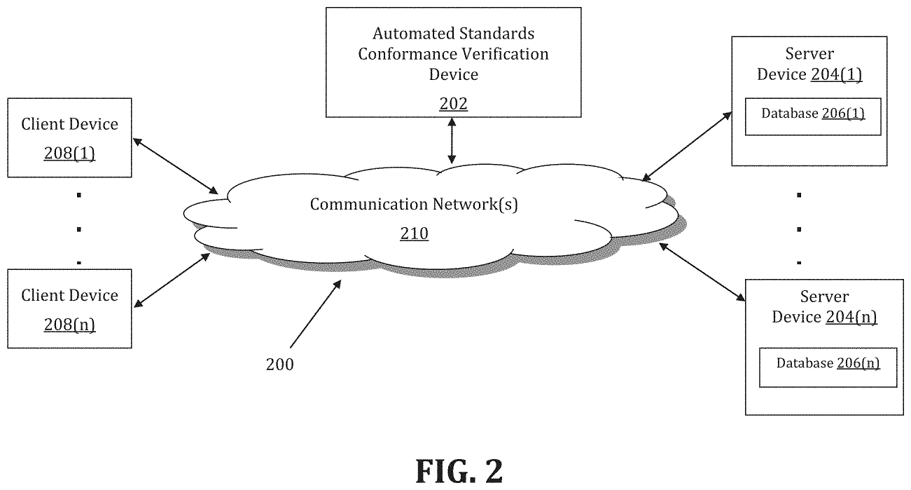

Referring to FIG. 2, a schematic of an exemplary network environment 200 for implementing a method for using artificial intelligence techniques to verify that business processes adhere to established standards and norms is illustrated. In an exemplary embodiment, the method is executable on any networked computer platform, such as, for example, a personal computer (PC).

The method for using artificial intelligence techniques to verify that business processes adhere to established standards and norms may be implemented by an Automated Standards Conformance Verification (ASCV) device 202. The ASCV device 202 may be the same or similar to the computer system 102 as described with respect to FIG. 1. The ASCV device 202 may store one or more applications that can include executable instructions that, when executed by the ASCV device 202, cause the ASCV device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ASCV device 202 itself, may be located in virtual servers) running in a cloud-based computing environment rather than being tied to one or more specific physical network computing devices. Also, the applications) may be running in one or more virtual machines (VMs) executing on the ASCV device 202. Additionally, in one or more embodiments of this technology, virtual machine(s) running on the ASCV device 202 may be managed or supervised by a hypervisor.

In the network environment 200 of FIG. 2, the ASCV device 202 is coupled to a plurality of server devices 204(1)-204(n) that hosts a plurality of databases 206(1)-206(n), and also to a plurality of client devices 208(1)-208(n) via communication network(s) 210. A communication interface of the ASCV device 202, such as the network interface 114 of the computer system 102 of FIG. 1, operatively couples and communicates between the ASCV device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ASCV device 202, the server devices 204(1)-204(n), and/or the client devices 208(1)-208(n) may be coupled together via, other topologies. Additionally, the network environment 200 may include other network devices such as one or more routers and/or switches, for example, which are well known in the art and thus will not be described herein. This technology provides a number of advantages including methods, non-transitory computer readable media, and ASCV devices that efficiently implement a method for using artificial intelligence techniques to verify that business processes adhere to established standards and norms.

By way of example only, the communication network(s) 210 may include local area network(s) LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form voice, modem, and the like), Public Switched Telephone Network (PSTNs), Ethernet-based Packet Data Networks (PDNs), combinations thereof, and the like.

The ASCV device 202 may be a standalone device or integrated with one or more other devices or apparatuses, such as one or more of the server devices 204(1)-204(n), for example. In one particular example, the ASCV device 202 may include or be hosted by one of the server devices 204(1)-204(n), and other arrangements are also possible. Moreover, one or more of the devices of the ASCV device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ASCV device 202 via the communication network(s) 210 according to the HTTP-based and/or JavaScript Object Notation (NON) protocol, for example, although other protocols may also be used.

The server devices 204(1)-204(n) may he hardware or software or may represent a system with multiple servers in a pool, which may include internal or external networks. The server devices 204(1)-204(n) hosts the databases 206(1)-206(n) that are configured to store data that relates to regulatory requirements, business standards and norms, and business process evidences and audit test data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ASCV device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ASCV device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ASCV device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ASCV device 202, the server devices 204(1)-204(n), or the client devices 208(1)-208(n), for example, may be configured to operate as virtual instances on the same physical machine. In other words, one or more of the ASCV device 202, the server devices 204(1)-204(n), or the client devices 208(1)-208(n) may operate on the same physical device rather than as separate devices communicating through communication network(s) 210. Additionally, there may be more or fewer ASCV devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

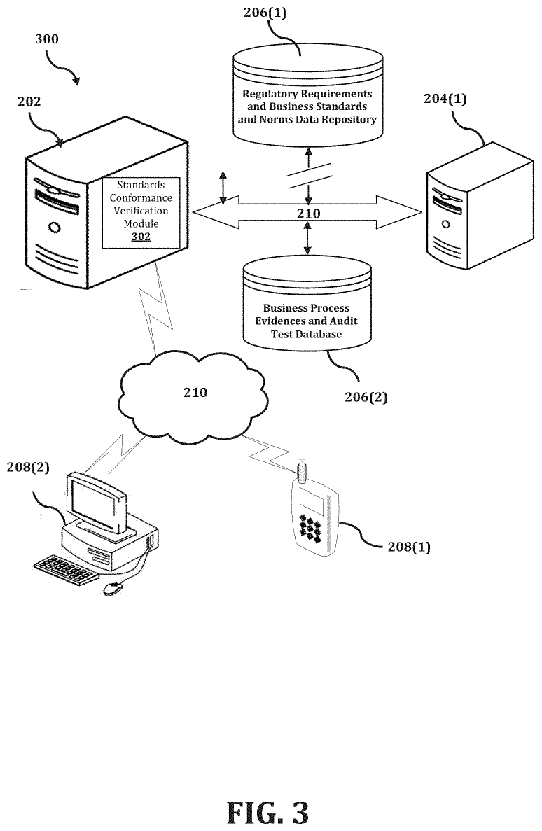

The ASCV device 202 is described and illustrated in FIG. 3 as including a standards conformance verification module 302, although it may include other rules, policies, modules, databases, or applications, for example. As will be described below, the standards conformance verification module 302 is configured to implement a method for using artificial intelligence techniques to verify that business processes adhere to established standards and norms.

An exemplary process 300 for implementing a mechanism for using artificial intelligence techniques to verify that business processes adhere to established standards and norms by utilizing the network environment of FIG. 2 is illustrated as being executed in FIG. 3. Specifically, a first client device 208(1) and a second client device 208(2) are illustrated as being in communication with ASCV device 202. In this regard, the first client device 208(1) and the second client device 208(2) may be “clients” of the ASCV device 202 and are described herein as such. Nevertheless, it is to be known and understood that the first client device 208(1) and/or the second client device 208(2) need not necessarily be “clients” of the ASCV device 202, or any entity described in association therewith herein. Any additional or alternative relationship may exist between either or both of the first client device 208(1) and the second client device 208(2) and the ASCV device 202. or no relationship may exist.

Further, ASCV device 202 is illustrated as being able to access a regulatory requirements and business standards and norms data repository 206(1) and a business process evidences and audit test database 206(2). The standards conformance verification module 302 may be configured to access these databases for implementing a method for using artificial intelligence techniques to verify that business processes adhere to established standards and norms.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ASCV device 202 via broadband or cellular communication. Of course, these embodiments are merely exemplary and are not limiting or exhaustive.

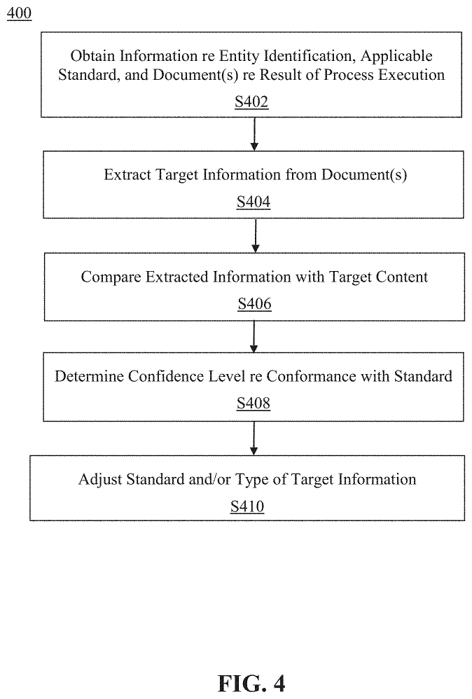

Upon being started, the standards conformance verification module 302 executes a method for using artificial intelligence techniques to verify that business processes adhere to established standards and norms. An exemplary process for using artificial intelligence techniques to verify that business processes adhere to established standards and norms is generally indicated at flowchart 400 in FIG. 4.

In method 400 of FIG. 4, at step S402, the standards conformance verification module 302 obtains information that indicates an identity of an entity that has executed a process, an applicable standard that relates to the process, and one or more documents that contain information that relates to a result of the execution of the process. In an exemplary embodiment, the applicable standard may include any one or more of a governmental regulation, a predetermined quality standard, and a standard that relates to ensuring that the process is executed smoothly.

At step S404, the standards conformance verification module 302 extracts target information from the document(s). The target information includes a predetermined type of information, such as, for example, a title of a document. In an exemplary embodiment, an identification of the document(s) and a determination of which information and/or which type of information is included in the target information may be implemented by monitoring a set of mouse clicks and keyboard strokes performed by a user while that user is manually executing a verification of standards conformance that corresponds to the method 400, and using a result of the monitoring to identify the documents and the relevant characteristics of the target information. The result of the monitoring may also be used to determine a portion of the document in which the target information is expected to exist, such as, for example, a page number or a set of page numbers.

At step S406, the standards conformance verification module 302 compares the information extracted in step S404 with a predetermined target content. In an exemplary embodiment, the target information may include a title of a document, and the target content may include a specific title, such as, for example, “Annual Report.” Alternatively, the target information may include other portions of a document, such as a structural artifact (i.e., a table or a chart), a section heading, a footer, a signature block, an abstract concept that is derived and/or inferred from document text such as the presence of a dialogue conversation or an embedded user comment, and/or any other suitable type of information.

At step S408, the standards conformance verification module 302 uses a result of the comparison performed in step S406 to determine a confidence level value with respect to whether the execution of the process has satisfied the applicable standard. For example, when the extracted information exactly matches the predetermined target content, the standards conformance verification module 302 may determine that the confidence level value is 100%, because the exact match indicates that the process has been executed in accordance with the requirements of the standard. As another example, when the extracted information does not exactly match the predetermined target content, the standards conformance verification module 302 may assign a value within a range of between 0% and 99% based on a degree of uncertainty indicated by a result of the comparison performed in step S406. In an exemplary embodiment, the confidence level value may indicate that a manual review of the result of the execution process is required in order to ensure an accurate determination as to whether there is a conformance with the applicable standard.

At step S410, the standards conformance verification nodule 302 uses the confidence level value determined in step S408 to make an adjustment with respect to the type of target information to be used in future verifications and/or an adjustment with respect to the applicable standard. In an exemplary embodiment, an artificial intelligence (AI) technique and/or a machine learning technique may be applied to a historical archive of results of a verification method to determine whether an adjustment regarding the target information to be extracted and/or the applicable standard should be made.

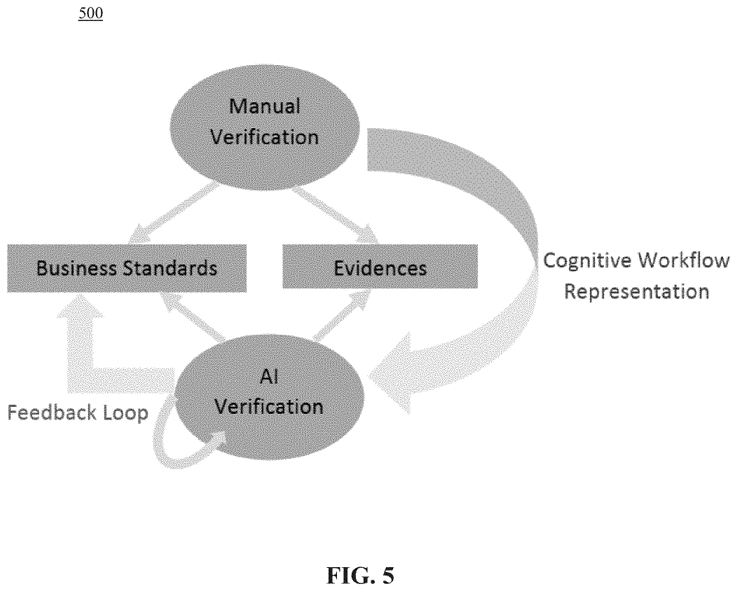

Unlike manual verification that is susceptible to human biases, inconsistencies and productivity, an artificial intelligence (AI)-driven system can produce an objective, consistent, and transparent verification system that can scale well. Referring to FIG. 5, in an exemplary embodiment, a solution includes three steps, as shown in a cognitive workflow representation diagram 500. Initially, the workflow involved in the manual verification procedure is captured and encoded in a format that is understandable by a machine. The cognitive workflow representation is used by an Al verification system to determine the adherence to standards based on the available evidences. The AI system quantifies the uncertainty in validation and thus may be used as part of a feedback loop to improve the verification and also to improve the business standards.

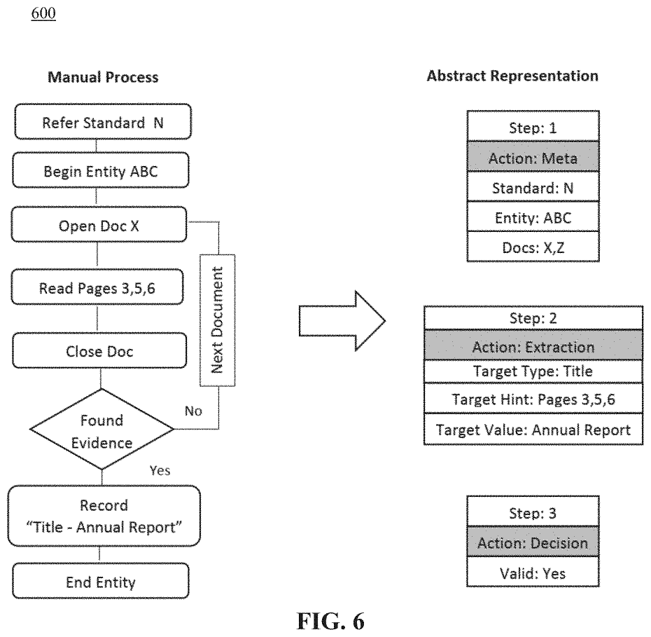

Referring to FIG. 6, in an exemplary embodiment, an essential requirement for AI-driven verification is to abstract and synthesize the manual process involved in verification into a format that the AI system can understand. In order to gain a deep understanding of the work decomposition, a sequence of logically related tasks involved in the manual process is illustrated in the diagram 600. This understanding of the work decomposition is achieved by monitoring typical actions carried out by human workers. One such way is to unobtrusively track mouse clicks and keyboard strokes and then record the set of actions executed by a user. These actions are then synthesized into an abstract representation that is machine-understandable.

Referring again to FIG. 6, the manual process targets a standard N which expects the presence of at least one document X that corresponds to an entity with a specific title. For an entity ABC for which the verification is to be performed, there are multiple documents available in the system. The user opens the first document, reads a particular set of pages, and then closes the document. If the user is satisfied that the required evidence is found in the document, then the user records the evidence type (e.g., Document Title) and the evidence value (e.g., an Annual Report document). Otherwise, the user proceeds to the next documentary evidence.

From the observation of this manual process, an abstract representation that summarizes the workflow is generated. The representation begins with a Meta action that refers the standard, entity, and available set of documentary evidences. Various types of actions are used to encode manual actions One such example is an Extraction action that signifies what type of value is extracted (e.g., the Title) and the expected value for this entity (e.g., Annual Report). Potential hints that assist in the process, such as positional information and page number(s), are also recorded. Further, the verification decision arrived at for this particular entity is also represented.

In an exemplary embodiment, the abstract representation generalizes the human actions into a finite set of logical tasks. The abstract representation is used by the AI system to automatically associate specific components with each task. For example, the AI system can infer that for verification of a particular standard, there is a need for an extraction component that may in turn require sub-components for document digitization, document parsing, entity resolution, and/or other functions. Further, the abstract representation also serves as an automatic training data generator. Each data item recorded in the representation can be used to derive training labels, thereby aiding in learning supervised learning models.

The sub-components used by the Al system provide a measure of the quality of their functional output. This facilitates a quantification of an uncertain encountered during various steps in the validation process. For example, consider a workflow that involves digitizing the documents, converting the digitized documents in to a structured representation, extracting relevant information, cross-correlating the information across documents, and arriving at a decision based on available evidence. Processing error may accumulate at each step and the machine captures these errors in the form of a confidence score. An aggregated score that signifies the reliability of the machine decision is presented at the end of the validation process. The user can configure the system to reject the validation after each step or at the final step. Based on the robustness of the estimated decision, the humans intervene to make a secondary inspection if necessary. This improves the overall quality of the verification and assists in building trust in the AI system.

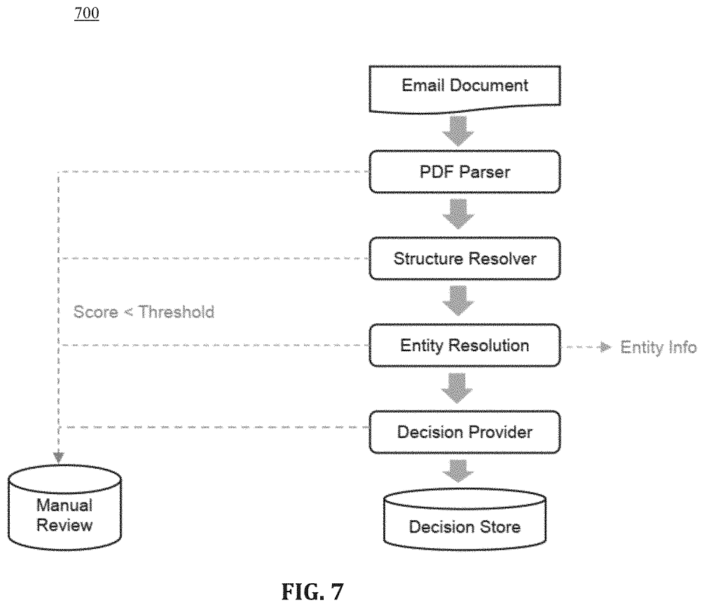

Referring to FIG. 7, an example of a verification system 700 that is used for validating whether entity information available in an email is present in the body of the email rather than in signature or header blocks is illustrated. The system includes sub-components for Portable Document Format (PDF) parsing, table structure identification, entity extraction, and conformance decision making. Each sub-component publishes its confidence level, and documents that fall below a user-specified threshold confidence level are automatically assigned for manual inspection.

Process Improvement: In an exemplary embodiment, the output produced. by the AI verification system may be used in a feedback loop to further improve the verification process and/or the overall business standards. For example, the system collects statistical properties about the availability and quality of evidence for each type of standard. While a manual verification may stop processing when the evidence is found, the AI system holistically considers all of the evidences available when verifying an entity and hence can build evidence profiles characterizing each entity. These details are used to analyze the distributional characteristics of the evidences across entities and the strengths and weaknesses in the business standards are highlighted. This serves as an indicator for how well the standard is being adhered to and alerts to non-conformance. Further, sub-components are trained iteratively in a weakly-supervised setting based on those abstract representations that resulted in highly confident decisions. Finally, the system connects information fragments across different documentary evidences to detect contradictions, inconsistencies, and anomalies.

Key Benefits: In an exemplary embodiment, the AI driven audit solution provides the following benefits: 1) Human errors such as pre-existing beliefs, overconfidence, and repetition boredom are eliminated, thereby improving the quality, reducing risk, and enhancing productivity. 2) A continuous audit flow is established to speed up operational time and receive early warning signals in case of widespread conformance issues. 3) The uncertainty quantification facilitates manual intervention where necessary, creating a partnership model of humans and AI in an augmented intelligence setting. 4) Better audit plans can be designed based on the improvements identified by the system.

Accordingly, with this technology, an optimized process for using artificial intelligence techniques to verify that business processes adhere to established standards and norms is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and. embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein tray broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for verifying that a process conforms to a standard, the method being implemented by at least one processor, the method comprising:
obtaining, by the at least one processor, first information that relates to a first entity that has executed a first process, the first information including an identification of the first entity, a standard that relates to the first process, and at least one document that relates to a result of an execution of the first process;
extracting, by the at least one processor, second information from the at least one document, the second information including a predetermined type of information; and
determining, by the at least one processor based on the extracted second information, whether the execution of the first process by the first entity satisfies the standard.

2. The method of claim 1, wherein the determining comprises comparing a content of the predetermined type of information with a predetermined target content and determining whether the execution of the first process by the first entity satisfies the standard based on a result of the comparing.

3. The method of claim 1, wherein the extracting comprises using information that indicates a predetermined portion of the at least one document within which the predetermined type of information is expected to exist to retrieve the second information.

4. The method of claim 3, further comprising:
monitoring a set of mouse clicks and keyboard strokes performed by a first user while the first user is determining whether an execution of the first process by a second entity satisfies the standard;
determining a document type of the at least one document based on a result of the monitoring; and
determining the predetermined type of information included in the second information and at least one from among the predetermined target content and the information that indicates a predetermined portion of the at least one document within which the predetermined type of information is expected to exist based on the result of the monitoring.

5. The method of claim 3, wherein the information that indicates a predetermined portion of the at least one document within which the predetermined type of information is expected to exist includes at least one page number of the at least one document.

6. The method of claim 1, wherein the predetermined type of information includes at least one from among a title of the at least one document, a table, a chart, a section heading, a footer, a signature block, a dialogue conversation, and an embedded user comment.

7. The method of claim 1, further comprising determining a confidence level value that relates to a degree of uncertainty with respect to the determining of whether the execution of the first process by the first entity satisfies the standard.

8. The method of claim 7, further comprising comparing the determined confidence level value with a predetermined threshold, wherein the determining of whether the execution of the first process by the first entity satisfies the standard is based on a result of the comparing.

9. The method of claim 7, further comprising using the determined confidence level value to adjust at least one from among the standard and the predetermined type of information to be used for determining whether the standard is satisfied in a future verification.

10. The method of claim 1, wherein the standard includes at least one from among a governmental regulation, a predetermined quality standard, and a standard that relates to ensuring that the process is executed smoothly.

11. A computing apparatus for verifying that a process conforms to a standard, the computing apparatus comprising:
a processor;
a memory; and
a communication interface coupled to each of the processor and the memory,
wherein the processor is configured to:
obtain first information that relates to a first entity that has executed a first process, the first information including an identification of the first entity, a standard that relates to the first process, and at least one document that relates to a result of an execution of the first process;
extract second information from the at least one document, the second information including a predetermined type of information; and
determine, based on the extracted second information, whether the execution of the first process by the first entity satisfies the standard.

12. The computing apparatus of claim 11, wherein the processor is further configured to compare a content of the predetermined type of information with a predetermined target content and to determine whether the execution of the first process by the first entity satisfies the standard based on a result of the comparison.

13. The computing apparatus of claim 11, wherein the processor is further configured to use information that indicates a predetermined portion of the at least one document within which the predetermined type of information is expected to exist to retrieve the second information.

14. The computing apparatus of claim 13, wherein the processor is further configured to:
monitor a set of mouse clicks and keyboard strokes performed by a first user while the first user is determining whether an execution of the first process by a second entity satisfies the standard;
determine a document type of the at least one document based on a result of the monitoring; and
determine the predetermined type of information included in the second information and at least one from among the predetermined target content and the information that indicates a predetermined portion of the at least one document within which the predetermined type of information is expected to exist based on the result of the monitoring.

15. The computing apparatus of claim 13, wherein the information that indicates a predetermined portion of the at least one document within which the predetermined type of information is expected to exist includes at least one page number of the at least one document.

16. The computing apparatus of claim 11, wherein the predetermined type of information includes at least one from among a title of the at least one document, a table, a chart, a section heading, a footer, a signature block, a dialogue conversation, and an embedded user comment.

17. The computing apparatus of claim 11, wherein the processor is further configured to determine a confidence level value that relates to a degree of uncertainty with respect to the determination of whether the execution of the first process by the first entity satisfies the standard.

18. The computing apparatus of claim 17, wherein the processor is further configured to compare the determined confidence level value with a predetermined threshold, and to determine whether the execution of the first process by the first entity satisfies the standard based on a result of the comparison.

19. The computing apparatus of claim 17, wherein the processor is further configured to use the determined confidence level value to adjust at least one from among the standard and the predetermined type of information to be used for determining whether the standard is satisfied in a future verification.

20. The computing apparatus of claim 11, wherein the standard includes at least one from among a governmental regulation, a predetermined quality standard, and a standard that relates to ensuring that the process is executed smoothly.
